(19) United States
(12) Patent Application Publication
(10) Pub. No.: US 2025/0306524 A1
(43) Pub. Date: Oct. 2, 2025

(54) IMAGE FORMING APPARATUS

(71) Applicant: BROTHER KOGYO KABUSHIKI KAISHA, Nagoya (JP)

(72) Inventors: Takaya WASHIO, Kitanagoya (JP); Kazuya KAMIKAWA, Nagoya (JP); Kazuya TAIRA, Nagoya (JP)

(73) Assignee: BROTHER KOGYO KABUSHIKI KAISHA, Nagoya (JP)

(21) Appl. No.: 19/088,174

(22) Filed: Mar. 24, 2025

(30) Foreign Application Priority Data
Mar. 26, 2024 (JP) 2024-050553
Mar. 26, 2024 (JP) 2024-050554
Mar. 26, 2024 (JP) 2024-050556
Nov. 15, 2024 (JP) 2024-200012
Nov. 15, 2024 (JP) 2024-200013
Nov. 15, 2024 (JP) 2024-200014

(51) Int. Cl. G03G 21/16; G03G 15/00

(52) U.S. Cl. CPC G03G 21/1647; G03G 15/6573; G03G 15/6579; G03G 21/1638; G03G 2221/1639; G03G 2221/1675; G03G 2221/169

(57) ABSTRACT

An image forming apparatus includes: a body housing; an image forming unit configured to form a developer image on a sheet; a fixing device configured to be detached from an accommodate compartment of the body housing and configured to fix the developer image on the sheet; an outer cover moveable between a closed position where the accommodate compartment is covered and an opened position where the accommodate compartment is uncovered; and a sheet guide provided between the fixing device and the outer cover and configured to guide, to the image forming unit, the sheet discharged from the fixing device. The sheet guide is rotatably supported by the body housing about a first guide axis, and is moveable between a working position close to the fixing device and a retracted position rotated from the working position to outside of the body housing.

### REFERENCE TO RELATED APPLICATIONS

This application claims priority from Japanese Patent Applications No. 2024-050553 filed on Mar. 26, 2024, No. 2024-050554 filed on Mar. 26, 2024, No. 2024-050556 filed on Mar. 26, 2024, No. 2024-200012 filed on Nov. 15, 2024, No. 2024-200013 filed on Nov. 15, 2024, and No. 2024-200014 filed on Nov. 15, 2024. The entire contents of these priority applications are incorporated herein by reference.

### BACKGROUND ART

In a related art, a color printer having a guide member that guides a sheet passed through a fixing unit to a return path for double-sided printing is known.

In the color printer described in the related art, a lower end portion of the guide member is rotatably connected to a device body. In a case where the fixing device is attachable and detachable, when the fixing device is detached, there is a possibility that the guide member falls into a space from which the fixing device is detached.

### SUMMARY

An object of the present invention is to provide an image forming apparatus capable of preventing, when a fixing device is attachable and detachable, a sheet guide from falling into a space from which the fixing device is detached.

In order to implement the above object, an image forming apparatus according to the present invention includes: a body housing; an image forming unit configured to form a developer image on a sheet; a fixing device configured to be detached from an accommodate compartment of the body housing and configured to fix the developer image on the sheet; an outer cover moveable between a closed position where the accommodate compartment is covered and an opened position where the accommodate compartment is uncovered; and a sheet guide provided between the fixing device and the outer cover and configured to guide, to the image forming unit, the sheet discharged from the fixing device. The sheet guide is rotatably supported by the body housing about a first axis, and is moveable between a working position close to the fixing device and a retracted position rotated from the working position to outside of the body housing.

In the present invention, the sheet guide is rotatably supported by the body housing, and is switchable between the working position close to the fixing device and the retracted position rotated to outside of the body housing. The fixing device can be easily attached and detached by locating the sheet guide at the retracted position when the outer cover is at the opened position. In addition, the sheet guide is provided with the regulating portion. Even when the sheet guide rotates toward the inside of the body housing in a state where the fixing device is detached, the rotation angle of the sheet guide is regulated by the regulating portion abutting against the abutment portion of the body housing. As a result, it is possible to prevent the sheet guide from entering a space from which the fixing device is detached.

According to the present invention, when the fixing device is attachable and detachable, it is possible to prevent the sheet guide from falling into the space from which the fixing device is detached.

### BRIEF DESCRIPTION OF DRAWINGS

FIG. 1 is a sectional view schematically illustrating an overall schematic structure of an image forming apparatus according to an embodiment.

FIG. 2 is a side sectional view illustrating an overall structure of the image forming apparatus in a state where an outer cover is at a closed position.

FIG. 3 is an enlarged sectional view illustrating a structure around a first spring in a section different from that of FIG. 2.

FIG. 4 is a side sectional view of the overall structure of the image forming apparatus in a state where the outer cover is at an opened position and a sheet guide is at a retracted position, which is based on a section different from that of FIG. 2.

FIG. 5 is a perspective view illustrating the image forming apparatus in a state where the outer cover is at the opened position and the sheet guide is at the retracted position.

FIG. 6 is a perspective view illustrating the image forming apparatus in a state where the outer cover is at the opened position and the sheet guide is at a working position.

FIG. 7A is an enlarged view illustrating the sheet guide at the working position in FIG. 6, and FIG. 7B is a cross-sectional view taken along line A-A in FIG. 7A.

FIG. 8 is a view of the sheet guide viewed from a side opposite to of FIG. 7A.

FIG. 9 is a perspective view illustrating a state where a fixing device is detached from the state illustrated in FIG. 5 via an opening.

FIG. 10 is an arrow view from a direction C in FIG. 8.

FIG. 11 is a sectional view taken along line B-B in FIG. 8.

FIG. 12 is a sectional view illustrating the overall structure of the image forming apparatus in a cross section different from that of FIG. 2.

FIG. 13 is an arrow view from a direction D of a main structure in FIG. 12.

FIG. 14 is a sectional view illustrating the overall structure of the image forming apparatus in a state where the sheet guide is substantially upright.

FIG. 15 is a partial extraction perspective view of the image forming apparatus illustrating the state where the sheet guide is substantially upright.

FIG. 16 is a sectional view illustrating the overall structure of the image forming apparatus in a state where a regulating portion of the sheet guide abuts against an abutment portion of a body housing and is regulated in rotation.

FIG. 17 is a view illustrating a main structure in FIG. 16 as viewed from the same direction as in FIG. 13.

FIG. 18 is a partial extraction perspective view of the image forming apparatus in a state where the regulating portion of the sheet guide abuts against the abutment portion of the body housing and is regulated in rotation.

### DESCRIPTION

Hereinafter, an embodiment of the present invention will be described in detail with reference to the drawings.

In the following description, the directions are described by directions based on a user at the time of using an image forming apparatus. That is, in the following drawings, “up”, “down”, “left”, “right”, “front”, and “rear” correspond to up, down, left, right, front, and rear directions as viewed from the user who uses the image forming apparatus. A left-right direction is a width direction of a sheet P on which an image is formed.

### Overview of Image Forming Apparatus

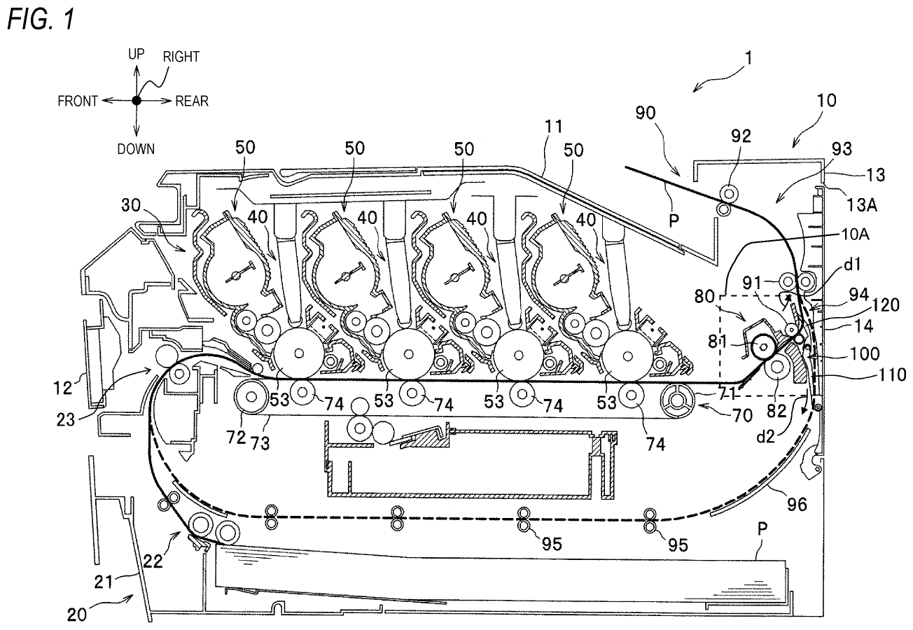

As illustrated in FIG. 1, an image forming apparatus 1 is a color printer in this example. The image forming apparatus 1 includes, in a body housing 10, a sheet feeding unit 20 that feeds the sheet P, an image forming unit 30 that forms an image on the fed sheet P, and a discharge unit 90 that discharges the sheet P on which the image is formed.

The sheet feeding unit 20 is provided at a lower portion in the body housing 10, and mainly includes a sheet feeding tray 21 attachably and detachably mounted on the body housing 10, and a sheet supply mechanism 22 that conveys the sheet P from the sheet feeding tray 21 to the image forming unit 30. In the sheet feeding unit 20, the sheet P in the sheet feeding tray 21 is separated one by one by the sheet supply mechanism 22, and is supplied to the image forming unit 30 in a state where an inclination of a leading end is regulated by a registration roller pair 23.

### Image Forming Unit

The image forming unit 30 mainly includes four LED units 40, four process cartridges 50, and a transfer unit 70. The image forming unit 30 forms a developer image on the sheet P.

The LED unit 40 is an exposure device including a plurality of LEDs in order to expose a corresponding photosensitive drum 53 to be described later. The process cartridge 50 includes the photosensitive drum 53 disposed to face an upper surface of a belt 73 to be described later, a known charger, a known developing roller, a known toner storage chamber, which are not illustrated, and the like. The transfer unit 70 is provided between the sheet feeding unit 20 and the process cartridges 50, and includes a drive roller 71, a driven roller 72, the belt 73, and transfer rollers 74.

In the image forming unit 30 configured as described above, first, a surface of each photosensitive drum 53 is uniformly charged by the charger, and then exposed by the corresponding LED unit 40. Accordingly, a potential of the exposed portion decreases, and an electrostatic latent image based on image data is formed on each photosensitive drum 53. Thereafter, a toner, which is a developer, is supplied to the electrostatic latent image by the developing roller, so that the developer image is supported on the photosensitive drum 53. Next, the sheet P supplied onto the belt 73 passes between the photosensitive drums 53 and the transfer rollers 74, the developer images, i.e., images, formed on the photosensitive drums 53 are transferred onto the sheet P.

### Fixing Device

The fixing device 80 fixes the developer image to the sheet P on which the developer image is formed by the image forming unit 30. The fixing device 80 includes a heating roller 81 and a pressing roller 82 that is disposed to face the heating roller 81 and presses the heating roller 81. In the fixing device 80 configured as described above, the sheet P to which the developer image is transferred passes between the heating roller 81 and the pressing roller 82, so that the developer image transferred onto the sheet P is thermally fixed.

### Discharge Unit

The discharge unit 90 mainly includes a plurality of pairs of conveyance rollers 91 and a pair of discharge rollers 92. A first discharge path 93 (solid line) that guides the sheet P printed by the image forming unit 30, that is, the fixed sheet P to a discharge tray 11 outside the body housing 10 is formed by the rollers 91 and 92, a guide, and the like. Specifically, in the first discharge path 93, the sheet P fed from the fixing device 80 toward an opening 13A to be described later at a rear side of the body housing 10 is guided to the discharge tray 11 at an upper side by a sheet guide 100 or the like to be described later.

A return path 94 (broken line) for returning the sheet P from the first discharge path 93 to an upstream side in a sheet conveyance direction of the image forming unit 30 is continuously connected to the first discharge path 93. The return path 94 is formed by a plurality of reverse conveyance rollers 95 and a guide 96.

In the discharge unit 90, at the time of single-sided printing, the sheet P discharged from the fixing device 80 is conveyed by the plurality of pairs of conveyance rollers 91 and the pair of discharge rollers 92 and discharged to the discharge tray 11. On the other hand, at the time of double-sided printing, the single-sided printed sheet P is discharged onto the discharge tray 11 to the middle by the discharge roller 92, then fed to the return path 94 by reverse rotation, that is, switchback, of the discharge roller 92, and resupplied to the upper stream side of the image forming unit 30 in a reverse rotation state.

A manual feed cover 12 that swings about a lower portion thereof is provided on a front side of the body housing 10. Then, the sheet P on the opened manual feed cover 12 is fed to the image forming unit 30 by the registration roller pair 23 and the like.

### Outer Cover

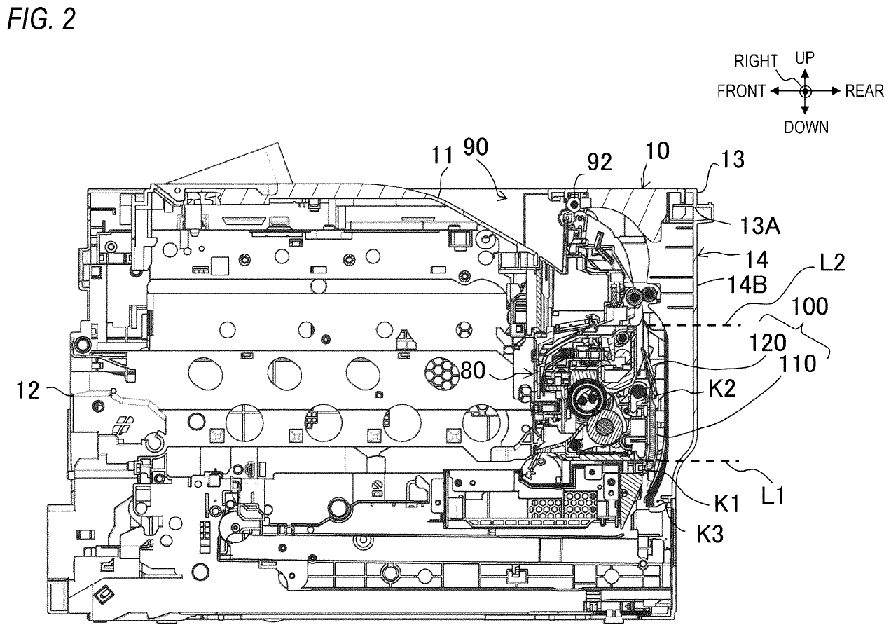

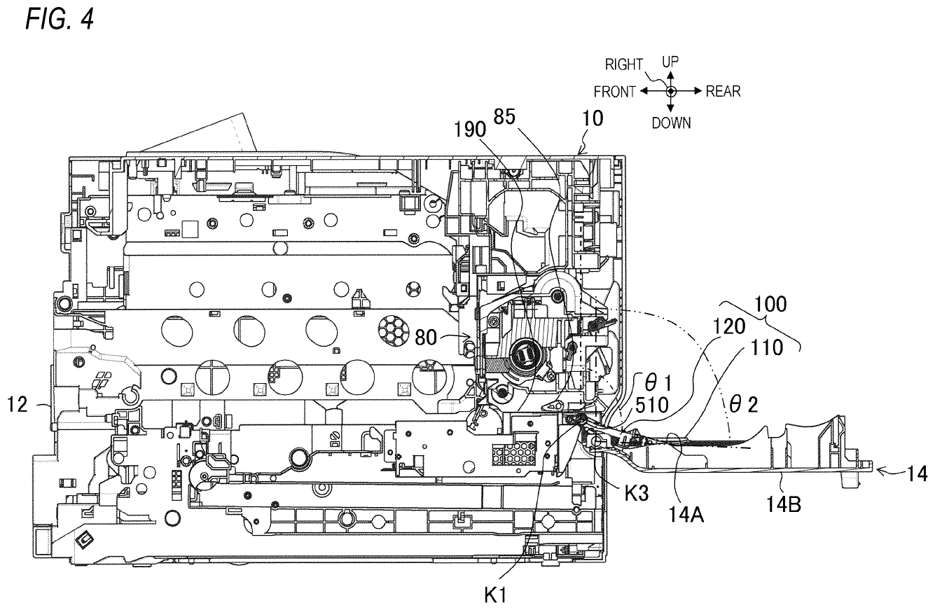

The body housing 10 has the opening 13A. Specifically, the opening 13A is formed in a rear wall 13 of the body housing 10. The opening 13A is opened and closed by the outer cover 14 that swings about a lower portion thereof. As illustrated in FIGS. 2 and 4, the outer cover 14 is rotatably supported by the body housing 10 about a cover axis K3 extending in the left-right direction, and may be moved between a closed position where the opening 13A is closed and an opened position where the opening 13A is opened. That is, FIG. 2 is a side sectional view of the image forming apparatus 1 showing a state where the outer cover 14 is at the closed position, FIG. 4 is a side sectional view of the image forming apparatus 1 showing a state where the outer cover 14 is at the opened position, which is based on a section different from that of FIG. 2.

### Sheet Guide

The sheet guide 100 that guides the sheet P is provided between the outer cover 14 and the fixing device 80. The sheet guide 100 guides, to the image forming unit 30, the sheet P discharged from the fixing device 80. At this time, the sheet guide 100 is rotatably supported by the body housing 10 about a first guide axis K1 extending in the left-right direction, and may be switched between a working position close to the fixing device 80 and a retracted position rotated to outside of the body housing 10 from the working position. As illustrated in FIGS. 2 and 4, the first guide axis K1 and the cover axis K3 are parallel to each other and are located on the same side with respect to the fixing device 80 when viewed from a direction along the first guide axis K1. A distance from the cover axis K3 to the fixing device 80 is longer than a distance from the first guide axis K1 to the fixing device 80. FIG. 2 shows a state where the sheet guide 100 is switched to the working position. In this state, the sheet guide 100 is sandwiched in contact with both the outer cover 14 and the fixing device 80. On the other hand, FIG. 4 shows a state where the sheet guide 100 is switched to the retracted position. As illustrated in FIG. 4, at the retracted position, the sheet guide 100 comes into contact with the outer cover 14 at the opened position. The first guide axis K1 is an example of a first axis.

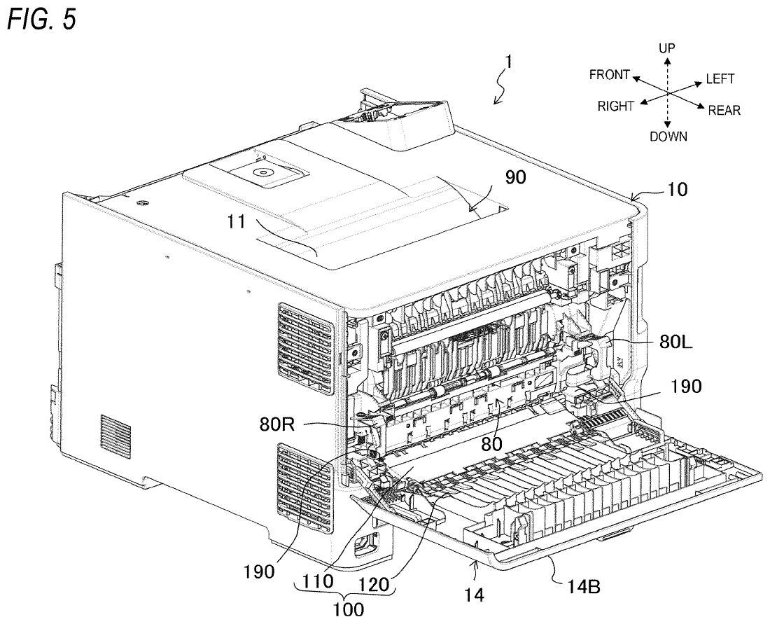

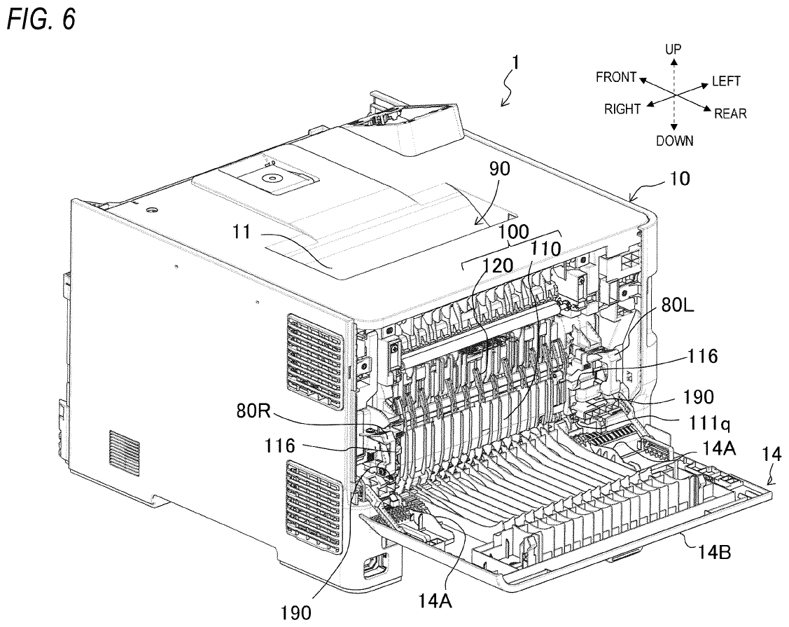

FIG. 5 is a perspective view illustrating an appearance of the image forming apparatus 1 in a state where the outer cover 14 is at the opened position and the sheet guide 100 is at the retracted position, as described above with reference to FIG. 4. FIG. 6 is a perspective view illustrating the appearance of the image forming apparatus 1 in a state where only the sheet guide 100 is rotated and switched to the working position from the state of FIG. 5.

### Base Portion and Distal End Portion

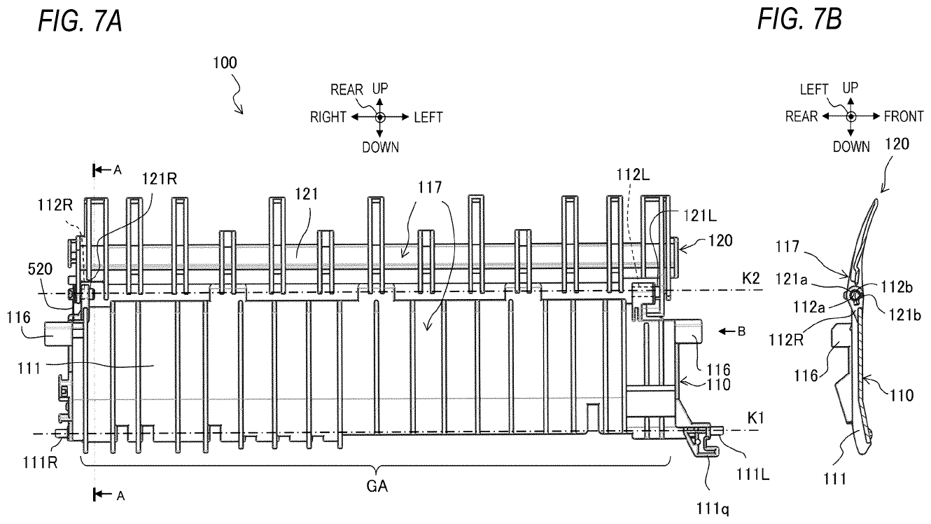

As illustrated in FIGS. 5 and 6, the sheet guide 100 includes a base portion 110 and a distal end portion 120. FIG. 7A illustrates an enlarged view of the sheet guide 100 at the working position in FIG. 6.

As illustrated in FIG. 7A, the base portion 110 includes a plate-shaped portion 111 which extends in an up-down direction that is the conveyance direction of the sheet P, and which is formed in an elongated plate shape that is thin in the left-right direction which is the width direction of the sheet P. A lower end portion of the plate-shaped portion 111 is rotatably supported by the body housing 10. Specifically, the base portion 110 is rotatably supported by the body housing 10 about the first guide axis K1.

The distal end portion 120 is provided with a rib coupling body 121 in which a plurality of plate-shaped rib members that are thin in the left-right direction and that extend to be curved obliquely forward and upward are coupled to each other at intervals in the left-right direction. The distal end portion 120 rotatably supports an upper end portion of the plate-shaped portion 111. Specifically, the distal end portion 120 is rotatably supported by the base portion 110 about a second guide axis K2 extending in the left-right direction. The second guide axis K2 is an example of a second axis.

The distal end portion 120 and the base portion 110 are made of materials different from each other, and the Young's modulus of the distal end portion 120 is larger than the Young's modulus of the base portion 110. That is, for example, the distal end portion 120 is made of PET including glass fibers. A reason why the distal end portion 120 is made of PET is that since the sheet P immediately after being discharged from the fixing device 80 comes into contact with the distal end portion 120, it is preferable that the distal end portion 120 has durability against the contact with the heated sheet P. On the other hand, the base portion 110 is made of, for example, ABS which is relatively soft.

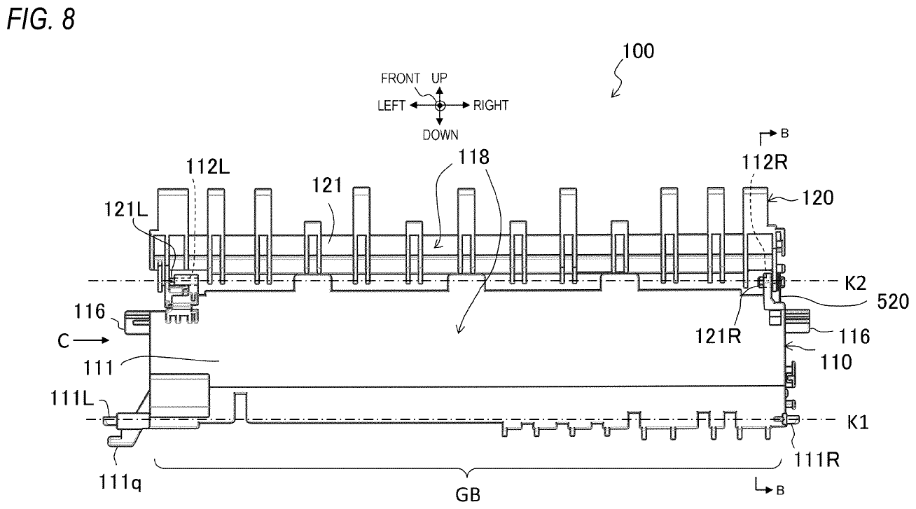

As illustrated in FIG. 7A and FIG. 7B, the base portion 110 and the distal end portion 120 of the sheet guide 100 each have an outer guide surface 117 provided with an outer guide region GA in which at the working position, the sheet guide 100 faces an outer cover 14 side. The outer guide region GA is an example of a guide region. As illustrated in FIG. 8 when viewed from a side opposite to FIG. 7A, the base portion 110 and the distal end portion 120 of the sheet guide 100 each have an inner guide surface 118 provided with an inner guide region GB in which at the working position, the sheet guide 100 faces a fixing device 80 side, which is a side opposite to the outer cover 14.

### Opening and Closing Operation of Sheet Guide

As illustrated in FIGS. 1 and 2, the sheet guide 100 having the above configuration extends substantially along the up-down direction when the outer cover 14 is at the closed position, and is disposed near a branch point between the first discharge path 93 and the return path 94 so as to face the opening 13A. In this state, since the base portion 110 is pressed by the outer cover 14 and does not move, the distal end portion 120 may rotate largely with respect to the base portion 110 which does not move. That is, the distal end portion 120 rotates when the outer cover 14 is at the closed position, so that the conveyance path of the sheet P is switched between the first discharge path 93 and the return path 94.

Specifically, in a case where the distal end portion 120 of the sheet guide 100 is pressed rearward by the sheet P discharged from the fixing device 80 in a state where the outer cover 14 is closed, the distal end portion 120 is retracted from the first discharge path 93, and the sheet P passes through the first discharge path 93. That is, the conveyance path of the sheet P is switched from the return path 94 to the first discharge path 93 by the distal end portion 120. That is, the inner guide surfaces 118 of the distal end portion 120 and the base portion 110 guide the sheet P discharged from the fixing device 80 in a first direction d1 (see FIG. 1), and at that time, in the inner guide region GB, the sheet guide 100 comes into contact with the sheet P discharged from the fixing device 80 and guides the sheet P.

Then, in a case where a trailing end of the sheet P is detached from the distal end portion 120, the distal end portion 120 returns to an original position by a biasing force of a second spring 520 (See FIG. 7A. Details will be described later). That is, the conveyance path of the sheet P is switched from the first discharge path 93 to the return path 94 by the distal end portion 120. Thereafter, in a case where the sheet P is conveyed in a reverse direction by switchback, the sheet P is guided in the outer guide region GA on a rear surface of the distal end portion 120 and fed to the return path 94. That is, the outer guide surfaces 117 of the distal end portion 120 and the base portion 110 guide, to the image forming unit 30, the sheet P discharged from the fixing device 80 in the first direction d1 and with the conveyance direction being reversed, conveyed in a second direction d2 opposite to the first direction d1. At that time, in the outer guide region GA, the sheet guide 100 comes into contact with the sheet P discharged from the fixing device 80 and guides the sheet P to the image forming unit 30. As a result, so-called double-sided printing with respect to the sheet P can be executed.

### First Feature of Embodiment

On the other hand, when a conveyance jam occurs in the middle of the above-described double-sided printing, it is necessary to open the outer cover 14 to eliminate the jam of the sheet P. The first feature of the present embodiment is a configuration in which the labor burden of the user processing can be reduced even when a conveyance jam occurs while ensuring the above-described easy attachment and detachment of the fixing device 80. Hereinafter, details of such a configuration will be described in order.

### Biasing by First Spring and Second Spring

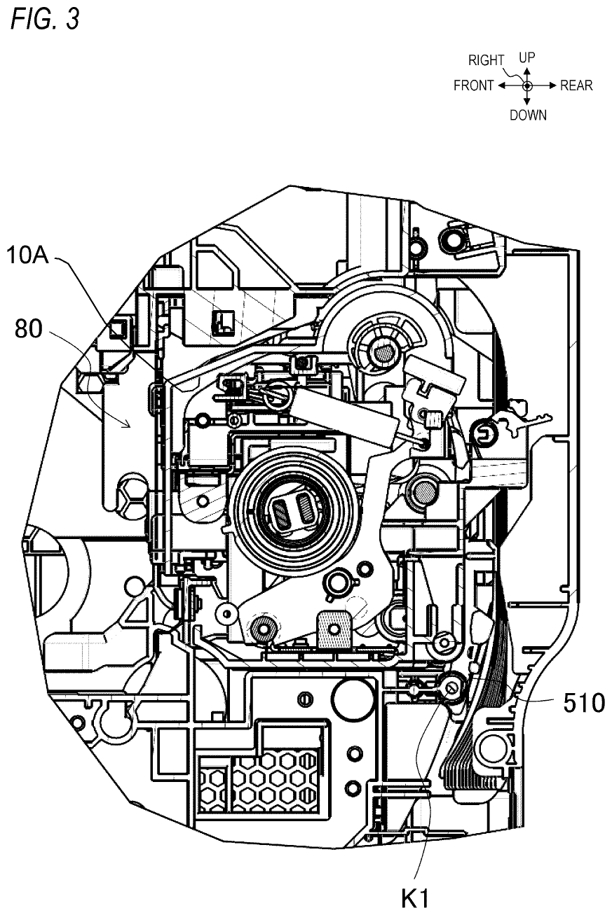

In the present embodiment, a first spring 510 that biases the sheet guide 100 is provided so that the sheet guide 100 is located at the retracted position when the outer cover 14 is at the opened position, as illustrated in FIGS. 3 and 4. In the illustrated example, a torsion coil spring is used as the first spring 510, but without being limited thereto, another type of spring such as a compression spring may be used as long as the same action as described above can be exerted. Except when the above-described compression spring is used, the first spring 510 continuously biases the sheet guide 100 while the sheet guide 100 is located at the retracted position.

In the present embodiment, the second spring 520 is provided to bias the distal end portion 120 to approach the fixing device 80 when the sheet guide 100 is at the working position, as illustrated in FIG. 7A and FIG. 8. The second spring 520 is a torsion coil spring, and the second guide axis K2 is located in the coil shape of the second spring 520. The second spring 520 is an example of a spring.

### Opening Operation of Outer Cover

In a case where the outer cover 14 is opened, the sheet guide 100 is pressed rearward by the biasing force of the first spring 510 to tilt about the first guide axis K1 such that an upper end side of the sheet guide 100 approaches the outer cover 14. At this time, the rotation of the distal end portion 120 is suppressed by the biasing force of the second spring 520, so that the distal end portion 120 is regulated from being folded so as to face the base portion 110. That is, the sheet guide 100 is tilted rearward while the distal end portion 120 and the base portion 110 are kept in a posture with orientation being substantially linearly aligned.

In a case where an upper end portion of the sheet guide 100 comes into contact with the outer cover 14, the sheet guide 100 is supported by the outer cover 14 (see FIGS. 4 and 5). That is, at the retracted position of the sheet guide 100, the distal end portion 120 of the sheet guide 100 comes into contact with the outer cover 14 at the opened position. In this state, the outer surface 14B of the outer cover 14 is substantially parallel to a bottom surface of the body housing 10 at the opened position. At this time, a rotation angle θ1 (see FIG. 4) of the base portion 110 of the sheet guide 100 from the working position illustrated in FIG. 2 to the retracted position illustrated in FIGS. 4 and 5 is larger than a rotation angle θ2 (see FIG. 4) of the outer cover 14 from the closed position illustrated in FIG. 2 to the opened position illustrated in FIGS. 4 and 5. In the illustrated example, the rotation angle θ2 of the outer cover 14 is about 90°, and the rotation angle θ1 of the sheet guide 100 is an angle larger than 02.

When the sheet guide 100 is at the retracted position, a second discharge path 97 extending from the fixing device 80 of the image forming unit 30 toward the outer cover 14 at the opened position through the opening 13A is formed. When the second discharge path 97 is configured in a state where the sheet guide 100 is at the retracted position in this manner, it is possible to perform so-called straight discharge in which, for example, the sheet P on the opened manual feed cover 12 is printed while being fed substantially straight in a front-rear direction and then discharged onto the outer cover 14. At that time, the sheet P may be guided and discharged onto the outer cover 14 by an inner surface of the sheet guide 100, that is, the inner guide surface 118. In the straight discharge, the sheet guide 100 also functions as an auxiliary tray for placing the trailing end of the sheet P.

The sheet guide 100 at the retracted position is not coupled to the outer cover 14 but is supported by the outer cover 14, and thus may be separated from the opened outer cover 14. Accordingly, even in a case where the sheet P is jammed between the outer cover 14 and the sheet guide 100 when the outer cover 14 is opened, the jammed sheet P may be easily removed simply by causing the sheet guide 100 against the biasing force of the first spring 510 as illustrated in FIG. 6.

### Attachment and Detachment of Fixing Device

Here, in the present embodiment, the fixing device 80 may be attachable to and detachable from the body housing 10 through the opening 13A. The body housing 10 includes an accommodate compartment 10A that can accommodate the fixing unit 80. The accommodate compartment 10A includes a wall surrounding the fixing unit 80, and outer cover side thereof is open for attachment and detachment of the fixing unit 80. That is, as illustrated in FIGS. 4 and 5, the sheet guide 100 is retracted from the attachment and detachment path of the fixing device 80 in a state where the outer cover 14 is at the opened position and the sheet guide 100 is at the retracted position, so that the fixing device 80 is attachable and detachable. In order to facilitate attachment and detachment at this time, the fixing device 80 includes gripping portions 80R and 80L protruding toward the outer cover 14 in a state of being attached to the body housing 10, as illustrated in FIGS. 5 and 6. The gripping portions 80R and 80L are portions gripped by the user at the time of attaching or detaching the fixing device 80. The outer cover movable between a closed position where the accommodate compartment is covered and an opened position where the accommodate compartment is uncovered.

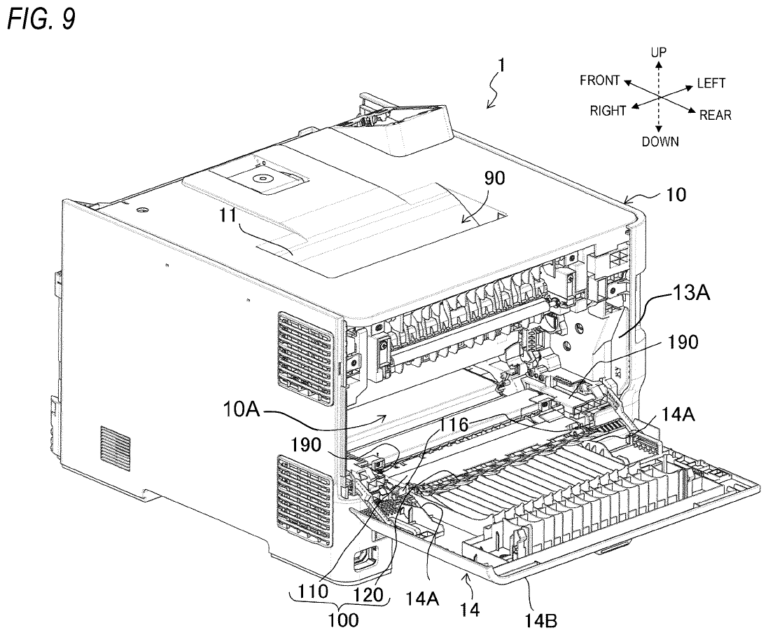

The gripping portions 80R and 80L are provided on both ends in the left-right direction, in other words, on one side and the other side along the first guide axis K1 described above. That is, a right side is an example of one side, and a left side is an example of the other side. As a result, the sheet guide 100, specifically, the distal end portion 120 thereof is located at the working position between the gripping portion 80R located on one side and the gripping portion 80L located on the other side, as illustrated in FIG. 6. FIG. 9 illustrates a state where the fixing device 80 is detached from the state illustrated in FIG. 5 via the opening 13A.

In order to smoothly perform the attachment and detachment operation, a fixing guide 190 that extends in the front-rear direction and guides attachment and detachment of the fixing device 80 is provided in the body housing 10, as illustrated in FIGS. 4, 5, 6, and 9. The fixing guide 190 is formed as a substantially horizontal plane in this example. As a result, the fixing guide 190 and the outer surface 14B of the outer cover 14 at the opened position are substantially parallel to each other, as illustrated in FIGS. 6 and 5. That is, in the present embodiment, an attachment and detachment direction of the fixing device is substantially horizontal in the front-rear direction. As illustrated in FIG. 4, a guided portion 85 of the fixing device 80 moves while sliding on an upper surface of the substantially horizontal fixing guide 190, so that the attachment and detachment operation of the fixing device 80 is guided. The guided portion 85 is a boss protruding in the left-right direction from the fixing device 80. The fixing guide 190 may not necessarily be completely parallel to the outer surface 14B of the outer cover 14. As described above, at this time, the sheet guide 100 is supported by the outer cover 14 (see FIGS. 4 and 5). Accordingly, even when the lower portion of the fixing device 80 comes into contact with the sheet guide 100 at the time of attaching and detaching the fixing device 80, the load and the impact can be supported by the outer cover 14.

### Opening Operation of Outer Cover

In a case where the outer cover 14 at the opened position is closed as described above, when the distal end of the outer cover 14 is raised, the upper portion of the sheet guide 100, that is, the distal end portion 120, swings upward while being supported by the outer cover 14. Thereafter, until the outer cover 14 is completely closed, a portion of the sheet guide 100 supported by the outer cover 14 is pressed forward by the outer cover 14 while changing from the distal end portion 120 to the base portion 110.

Thereafter, in a case where the upper end of the distal end portion 120 abuts against the fixing device 80, the base portion 110 is pressed forward by the outer cover 14 toward the distal end portion 120 of which the movement is stopped, and swings. Then, an angle between the distal end portion 120 and the base portion 110 is opened against the biasing force of the second spring 520, and the upper end of the distal end portion 120 is pressed toward the fixing device 80. As a result, only by closing the outer cover 14, the sheet guide 100 is at a normal position at the same time, that is, a position where the first discharge path 93 and the return path 94 may be switched. In a state where the outer cover 14 is closed, the base portion 110 is in a state of not moving by the above-described pressing, and the distal end portion 120 is in a state of having a degree of freedom capable of executing the above-described switching.

### Pressing of Sheet Guide by Outer Cover

In response to the above-described pressing of the sheet guide 100 by the outer cover 14, in the present embodiment, the outer cover 14 is provided with pressing portions 14A, as illustrated in FIGS. 4, 6, and 9. The pressing portions 14A are provided at both ends in the left-right direction of a surface of the outer cover 14 opposite to the outer surface 14B. When the outer cover 14 is at the closed position, the pressing portions 14A press the sheet guide 100 to be located at the working position.

As illustrated in FIGS. 6, 7, 8, and 9, the sheet guide 100 includes pressed portions 116 in contact with the respective pressing portions 14A at positions corresponding to the pressing portions 14A of the outer cover 14. As illustrated in FIGS. 7 and 8, the pressed portions 116 each have a protruding shape toward the outer cover 14. The pressed portions 116 are located outside of the outer guide region GA of the sheet guide 100 in the left-right direction, that is, in the width direction of the sheet P.

### Second Feature of Embodiment

The second feature of the present embodiment is that, in order to ensure smooth attachment and detachment of the fixing device 80 as described above, the first guide axis K1 is disposed at a position that does not hinder attachment and detachment. That is, in the present embodiment, when the sheet guide 100 is at the working position, the first guide axis K1 is not located between the fixing device 80 and the outer cover 14, as illustrated in FIG. 2. In short, the first guide axis K1 is located at a position that does not overlap the above-described attachment and detachable path of the fixing device 80. Specifically, the first guide axis K1 is located lower than a line L1 obtained by extending a lower end of the fixing device 80 in the attachment and detachment direction. On the other hand, when the sheet guide 100 is at the working position, the second guide axis K2 is located between the fixing device 80 and the outer cover 14. Specifically, the second guide axis K2 is located between a line L2 obtained by extending an upper end of the fixing device 80 in the attachment and detachment direction and the line L1 obtained by extending the lower end of the fixing device 80 in the attachment and detachment direction. Between the line L2 obtained by extending the upper end of the fixing device 80 in the attachment and detachment direction and the line L1 obtained by extending the lower end of the fixing device 80 in the attachment and detachment direction is the attachment and detachable path of the fixing device 80. The line L1 corresponds to an upper end of the accommodate compartment 10A. The line L2 corresponds to a lower end of the accommodate compartment 10A.

In the sheet guide 100, a support structure is adopted for fitting a boss and a hole, in order to smoothly perform the rotation of the base portion 110 about the first guide axis K1 and the rotation of the distal end portion 120 about the second guide axis K2. Hereinafter, details thereof will be described.

### Details of Support Structure of Base Portion

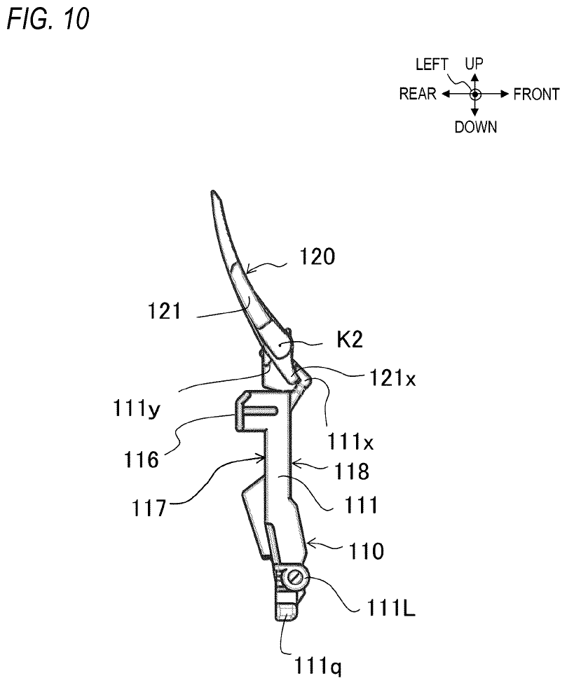

The base portion 110 of the sheet guide 100 has two first bosses 111R and 111L, as illustrated in FIG. 7A, FIG. 8, and FIG. 10 which is an arrow view from a direction C in FIG. 8.

The first bosses 111R and 111L protrude to both ends in the left-right direction, that is, both ends on one side and the other side along the first guide axis K1 so as to face opposite sides on the first guide axis K1. That is, the right side is an example of one side, and the left side is an example of the other side. Correspondingly, the body housing 10 has two first holes disposed on both left and right sides, in which the two first bosses 111R and 111L are respectively inserted and of which the reference numerals are omitted. The first hole is an example of a hole.

The first boss 111R is inserted into the first hole on the right side of the two first holes, and the first boss 111L is inserted into the first hole on the left side of the two first holes, so that the base portion 110 is supported by the body housing 10 in a manner of being rotatable about the first guide axis K1.

### Details of Support Structure of Distal End Portion

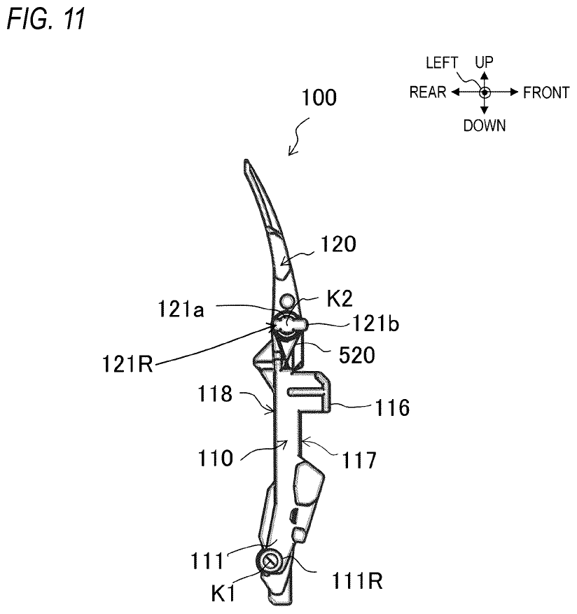

The distal end portion 120 has two second bosses 121R and 121L, as illustrated in FIG. 7A, FIG. 8, and FIG. 11 which is a sectional view taken along line B-B in FIG. 8.

The second bosses 121R and 121L protrude from both ends in the left-right direction, that is, both ends of one side and the other side along the second guide axis K2 so as to face each other on the second guide axis K2. That is, the right side is an example of one side, and the left side is an example of the other side. Correspondingly, the base portion 110 has two second holes 112R and 112L into which the two second bosses 121R and 121L are respectively inserted at both ends of one side and the other side.

The second boss 121R is inserted into the second hole 112R on the right side of the two second holes 112R and 112L, and the second boss 121L is inserted into the second hole 112L on the left side, so that the distal end portion 120 is supported by the base portion 110 in a manner of being rotatable about the second guide axis K2.

### Engagement Structure of Second Boss on Right Side

In the present embodiment, in particular, the second boss 121R on the right side of the two second bosses 121R and 121L of the distal end portion 120 has an engagement structure with a base portion 110 side. That is, the second hole 112R on one side of the base portion 110 has a through hole 112a which is circular and an engagement groove 112b that extends along the through hole 112a and is recessed radially outward from the through hole 112a, as illustrated in FIG. 7B.

The second boss 121R on one side includes a boss body 121a which is columnar and an engagement projection 121b protruding radially outward from the boss body 121a, as illustrated in FIG. 7B and FIG. 11. The engagement projection 121b comes into contact with an edge portion on one side of the second hole 112R on the one side in a state of being assembled through the engagement groove 112b. In assembling, the second boss 121R is inserted into the second hole 112R while the engagement projection 121b is engaged with the engagement groove 112b of the second hole 112R of the base portion 110. After the insertion, the engagement projection 121b comes into contact with the edge portion of the second hole 112R to implement escape stop of the second boss 121R from the second hole 112R.

### Rotation Stop

In the present embodiment, a rotation stop structure is also provided in order to limit the angle formed by the base portion 110 and the distal end portion 120 of the sheet guide 100 to a predetermined range, in addition to the above-described escape stop.

That is, a protrusion wall portion 111x is provided on a left portion of the base portion 110, as illustrated in FIG. 10. The protrusion wall portion 111x protrudes toward the second guide axis K2 at a position spaced radially outward from the second hole 112L on the left side. Correspondingly, an abutment projection portion 121x is provided on the left portion of the distal end portion 120. The abutment projection portion 121x protrudes radially outward from the second boss 121L on the left side and may abut against the protrusion wall portion 111x. As a result, in a configuration in which the above-described distal end portion 120 is rotatable with respect to the base portion 110, the abutment occurs at a certain angle when the abutment projection portion 121x approaches the protrusion wall portion 111x, so that a certain limitation is imposed on the rotation angle in that direction.

A protrusion wall portion 111y for restricting the rotation of the distal end portion 120 in a direction opposite to the protrusion wall portion 111x is further provided on a right portion of the base portion 110. When the distal end portion 120 rotates in a direction opposite to the direction in which the abutment projection portion 121x approaches the protrusion wall portion 111x, the abutment projection portion 121x may come close to the protrusion wall portion 111y and abut against the protrusion wall portion 111y. In the same manner as described above, in a configuration in which the distal end portion 120 is rotatable with respect to the base portion 110, the abutment occurs at a certain angle when the abutment projection portion 121x comes close to the protrusion wall portion 111y, so that a certain limitation is applied to the rotation angle in that direction.

As a result, in the present embodiment, the base portion 110 and the distal end portion 120, which are assembled to be rotatable relative to each other, are provided with a degree of freedom of rotation in a range from a state where the abutment projection portion 121x abuts against the protrusion wall portion 111x to a state where the abutment projection portion 121x abuts against the protrusion wall portion 111y.

### Third Feature of Embodiment

As described above, in a case where the fixing device 80 is detached via the opening 13A by setting the outer cover 14 to the opened position, when the sheet guide 100 falls into a space from which the fixing device 80 is detached, this hinders the fixing device 80 being inserted again. The third feature of the present embodiment is that the sheet guide 100 can be prevented from falling into the space from which the fixing device 80 is detached. Hereinafter, details thereof will be described in order.

### Rotation Regulating Portion

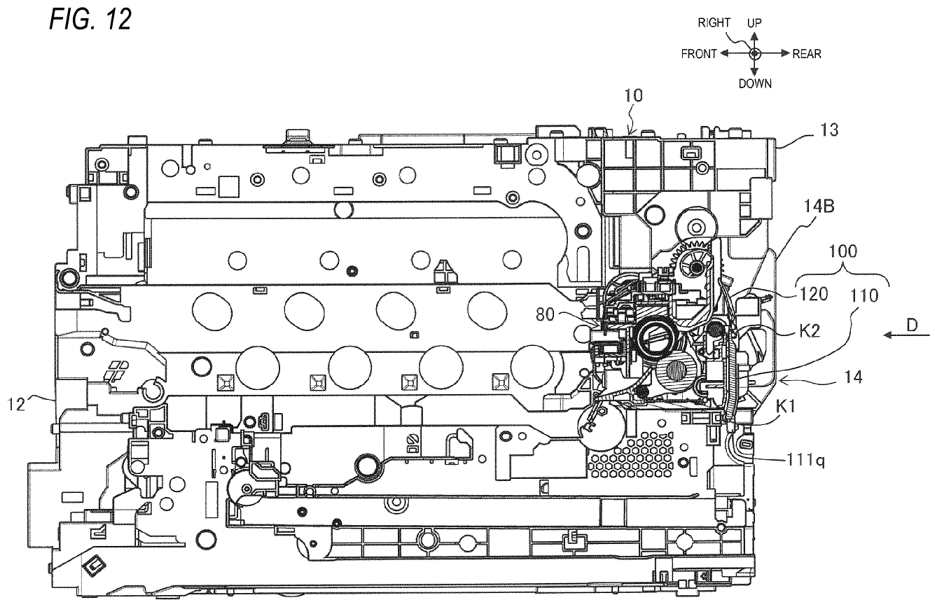

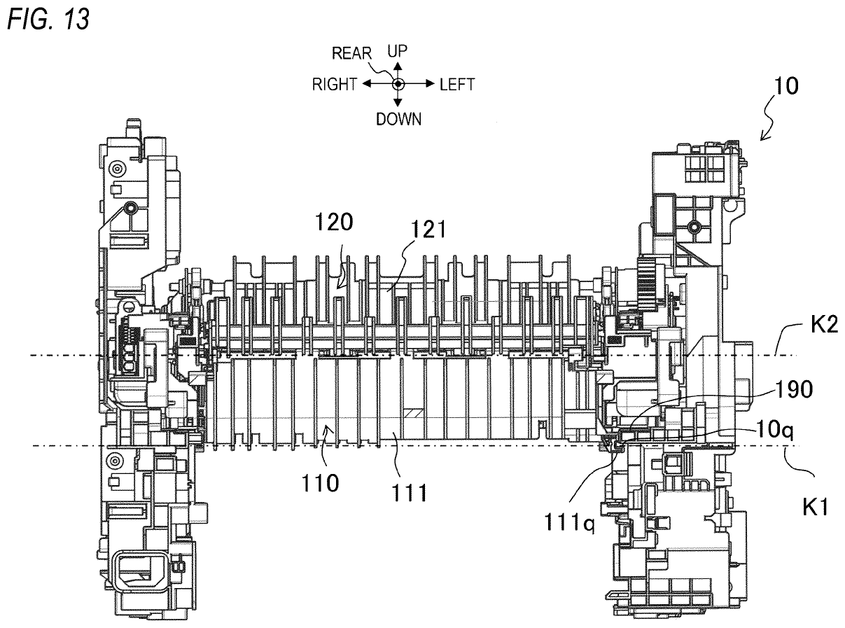

That is, the sheet guide 100 has a regulating portion 111q at a predetermined location shifted from the first guide axis K1 in the radial direction, as illustrated in FIG. 12, which is a sectional view illustrating the structure of the image forming apparatus 1 in a section different from that of FIG. 2, and FIGS. 6, 7, 8, and 10 described above. The predetermined location is, specifically, a location shifted in a direction away from the fixing device 80 than the first guide axis K1, as illustrated in FIG. 13, which is an arrow view of the main structure in FIG. 12 viewed from a direction D. The regulating portion 111q protrudes in a direction along the first guide axis K1 at a predetermined location, as illustrated in FIGS. 7 and 8. In other words, the regulating portion 111q protrudes outward in the width direction of the sheet P at the predetermined location. In the sheet guide 100, the regulating portion 111q is located outside of the outer guide region GA and the inner guide region GB in the left-right direction, that is, the width direction of the sheet P, as illustrated in FIGS. 7 and 8.

The body housing 10 is provided with an abutment portion 10q corresponding to the regulating portion 111q. In this example, the abutment portion 10q is provided at a portion on the right side of the left and right sides of the body housing 10, as illustrated in FIGS. 6 and 13. In this example, the abutment portion 10q is provided immediately below the fixing guide 190 for attachment, detachment, and guiding of the fixing device 80.

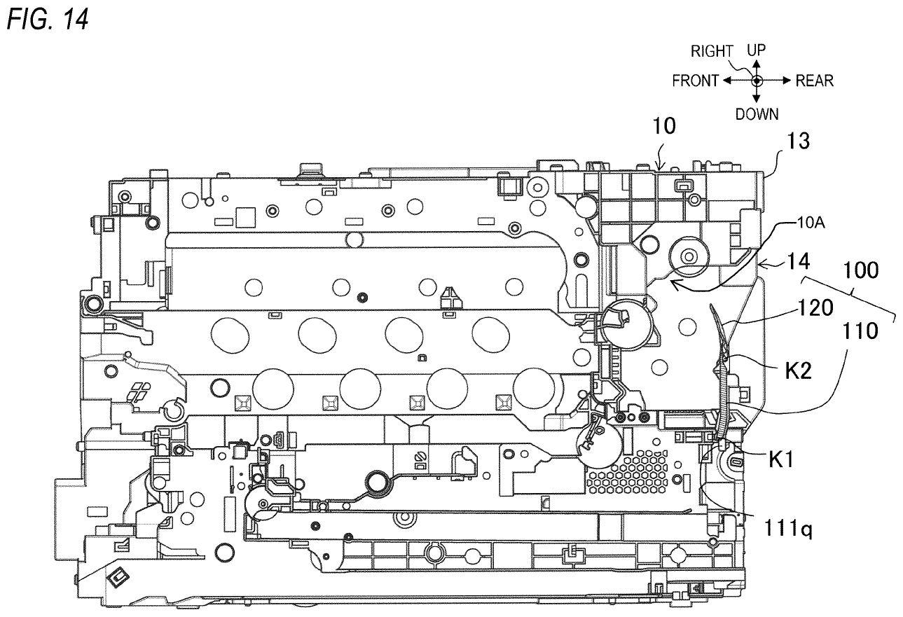

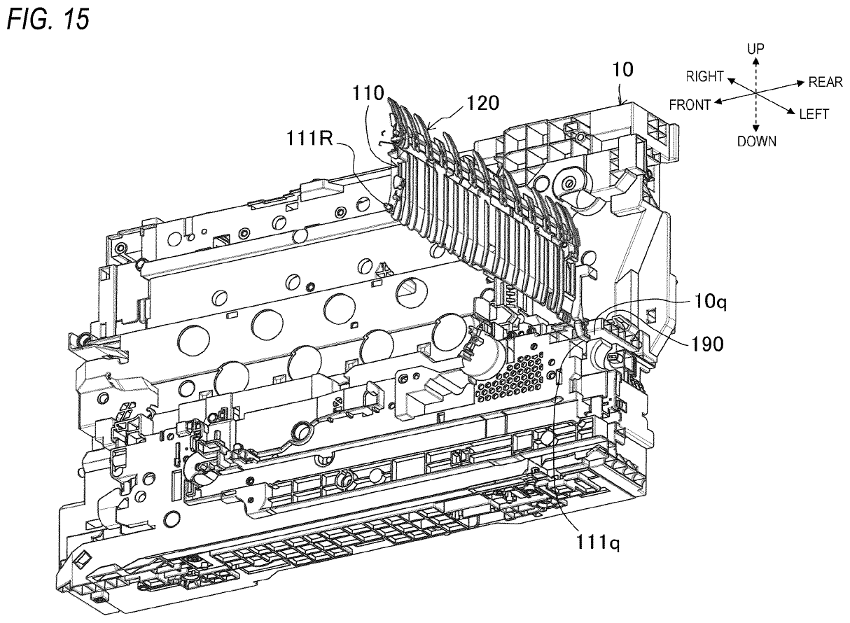

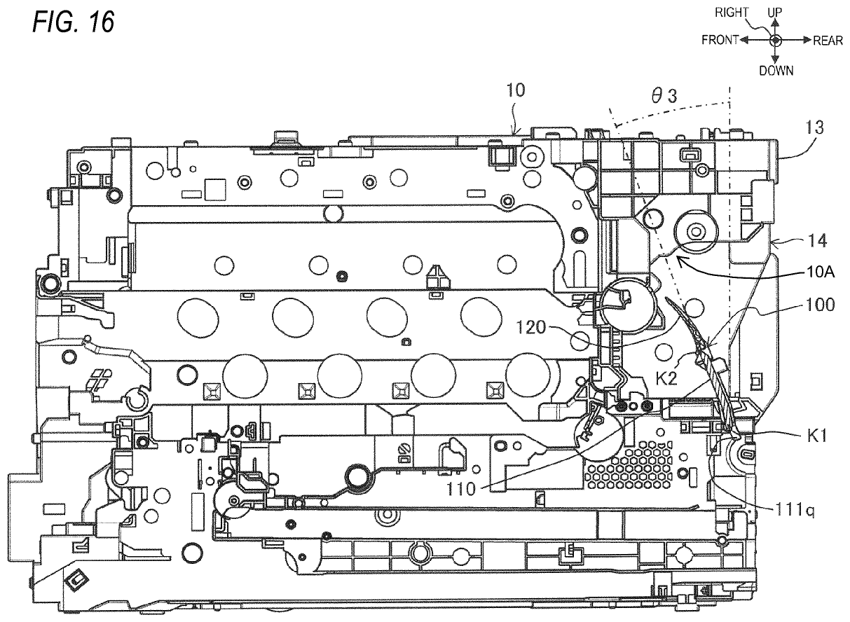

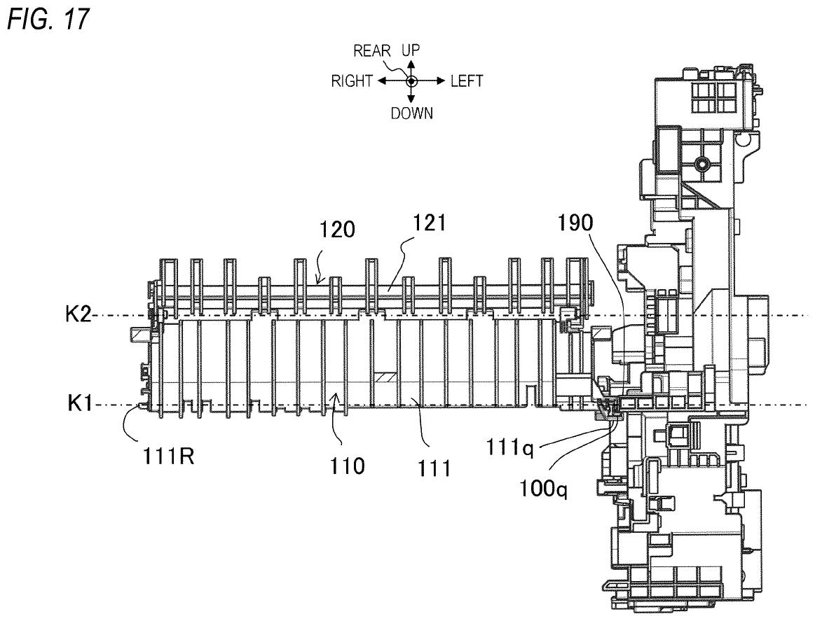

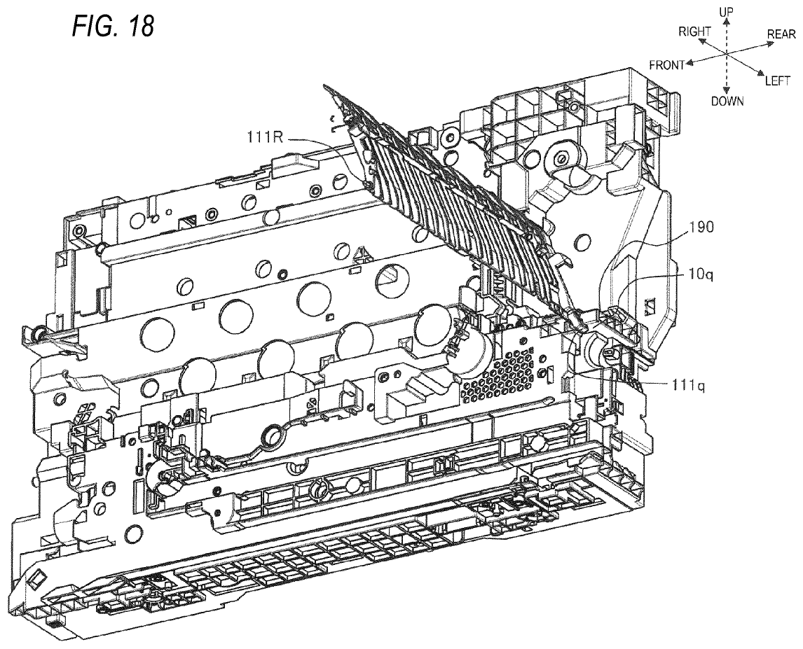

In the above configuration, the sheet guide 100 in the substantially upright state illustrated in FIGS. 14 and 15 has a predetermined gap between the regulating portion 111q and the abutment portion 10q. In a case where the sheet guide 100 is rotated about the first guide axis K1 from this state and falls forward and the rotation angle thereof reaches an angle θ3 illustrated in FIG. 16, the regulating portion 111q abuts against the abutment portion 10q of the body housing 10 as illustrated in FIGS. 17 and 18, thereby prohibiting the sheet guide 100 from further falling forward. That is, when the regulating portion 111q abuts against the abutment portion 10q of the body housing 10, an angle at which the sheet guide 100 rotates from the working position to the inside of the accommodate compartment 10A about the first guide axis K1 is regulated. In other words, the sheet guide 100 is allowed to rotate to the inside of the accommodate compartment 10A from the state illustrated in FIG. 14 to the state illustrated in FIG. 16. As described above, the working position of the sheet guide is determined by the outer cover 14 abutting against the sheet guide 100 when the outer cover 14 is closed, and thus a certain degree of freedom of rotation with respect to the sheet guide 100 is provided.

At this time, as can be seen from comparison between FIG. 16 and FIG. 4, the rotation angle θ1 from the working position of the sheet guide 100 to the retracted position is larger than the rotation angle θ3 from the working position of the sheet guide 100 to the regulated position by the regulating portion 111q.

In the present embodiment, the regulating portion 111q and the abutment portion 10q are provided only on the right side, which is an example of one side, of the left and right sides, and may be provided only on the left side, which is an example of the other side.

At this time, in particular, at the working position, the sheet guide 100 may be configured such that a center of gravity of the sheet guide 100 is located at a position closer to the outside of the body housing 10 than the first guide axis K1. However, in the present embodiment, the first spring 510 is used to rotate the sheet guide 100 to the outside as described above, but even when the first spring 510 is provided, it is preferable that the direction of rotation by gravity and the direction of rotation by the spring are the same because the biasing force of the first spring 510 can be set to be small.

### Effects of Embodiment

In the present embodiment configured as described above, the sheet guide 100 is rotatably supported by the body housing 10, and may be moved between a working position close to the fixing device 80 and a retracted position rotated to the outside of the body housing 10. When the outer cover 14 is at the opened position, the fixing device 80 can be easily attached and detached by locating the sheet guide 100 at the retracted position. The sheet guide 100 is provided with the regulating portion 111q. Even when the sheet guide 100 is rotated toward the inside of the accommodate compartment 10A in a state where the fixing device 80 is detached, the rotation angle of the sheet guide 100 is regulated by the regulating portion 111q abutting against the abutment portion 10q of the body housing 10. As a result, it is possible to prevent the sheet guide 100 from entering a space from which the fixing device 80 is detached. In particular, in the case of the above-described configuration in which the first spring 510 is not provided in the image forming apparatus 1, the possibility that the sheet guide 100 enters the space from which the fixing device 80 is detached is increased, and thus the above effect is effective. In order to exert this effect, the above-described configuration in which the distal end portion 120 of the sheet guide 100 is rotatable with respect to the base portion 110 is unnecessary.

In the present embodiment, in particular, the regulating portion 111q protrudes in a direction along the first guide axis K1. Accordingly, the regulating portion 111q may be disposed outside of a conveyance path of the sheet P along the direction of the first guide axis K1, and thus does not interfere with the conveyance path of the sheet P.

In the present embodiment, in particular, the sheet guide 100 includes the outer guide surface 117 and the inner guide surface 118. The regulating portion 111q is provided outside of the outer guide region GA of the outer guide surface 117 and the inner guide region GB of the inner guide surface 118. Accordingly, the regulating portion 111q does not interfere with the conveyance path of the sheet P.

In the present embodiment, in particular, the predetermined location where the regulating portion 111q is provided is shifted from the first guide axis K1 in a direction away from the fixing device 80. Accordingly, the first guide axis K1 can be brought close to the fixing device 80. When the sheet guide 100 is at the working position, in a case where the center of gravity of the sheet guide 100 is located outside of the accommodate compartment 10A, the sheet guide 100 is more likely to rotate from the working position to the outside by its own weight, and thus it is possible to reliably prevent the sheet guide 100 from entering the space from which the fixing device 80 is detached.

In the present embodiment, in particular, the two first bosses 111R and 111L of the sheet guide 100 are inserted into the two first holes of the body housing 10, respectively, so that the sheet guide 100 is rotatably disposed. At this time, the regulating portion 111q of the sheet guide 100 and the abutment portion 10q of the body housing 10 are disposed on one side or the other side along the first guide axis K1, that is, on a single side. In this manner, by disposing the regulating portion 111q on only a single side, the size of the assembly of the sheet guide 100 and the body housing 10, in other words, the size of the entire image forming apparatus 1 can be reduced.

In the present embodiment, in particular, the rotation angle θ1 of the sheet guide 100 from the working position to the retracted position toward the outside of the body housing 10 is larger than the rotation angle θ3 toward the inside of the accommodate compartment 10A from the working position to the regulated position of the regulating portion 111q. In this manner, by configuring the sheet guide 100 to rotate largely outward, the fixing device 80 is easily attached and detached.

As described above, in the present embodiment, the outer cover 14 may be switched between the opened position and the closed position, and the sheet guide 100 may be switched between the working position and the retracted position. When printing is performed in a state where the fixing device 80 is attached, it is necessary that the outer cover 14 is at the closed position and the sheet guide 100 is at the working position. Therefore, in the present embodiment, in particular, the outer cover 14 is provided with the pressing portion 14A, and the pressing portion 14A presses the pressed portion 116 of the sheet guide 100. Accordingly, the sheet guide 100 can be located at the working position.

In the present embodiment, in particular, the pressed portion 116 of the sheet guide 100 is located outside of the outer guide region GA of the outer guide surface 117. Accordingly, the pressed portion 116 is prevented from affecting conveyance of the sheet P in the outer guide region GA of the outer guide surface 117.

In the present embodiment, in particular, the pressed portion 116 of the sheet guide 100 has a shape protruding toward the outer cover 14. Accordingly, it is possible to define the conveyance path of the sheet P, which is formed by a gap between the outer guide surface 117 of the sheet guide 100 and the outer cover 14.

In the present embodiment, in particular, the outer cover 14 is rotatably supported by the body housing 10. The cover axis K3 during rotation is parallel to the first guide axis K1 of the sheet guide 100, and is located on the same side as the first guide axis K1 with respect to the fixing device 80. Accordingly, in a case where the outer cover 14 is opened about the cover axis K3, the sheet guide 100 thus rotates about the first guide axis K1 and retracts to the retracted position.

In the present embodiment, in particular, the sheet guide 100 is supported by the outer cover 14 and thus does not interfere with the attachment and detachment of the fixing device 80.

In the present embodiment, in particular, the cover axis K3 is located farther from the fixing device 80 than the first guide axis K1, and the rotation angle θ1 of the sheet guide 100 is larger than the rotation angle θ2 of the outer cover 14 rotating about the cover axis K3. Accordingly, when the outer cover 14 is at the opened position and the sheet guide 100 is at the retracted position, the sheet guide 100 located on an attachment and detachment path side of the fixing device 80 can be retracted more largely, and the fixing device 80 is easily attached and detached.

### Modification

The present invention is not limited to the above-described embodiment, and various modifications are possible without departing from the gist and technical idea of the above-described embodiment.

That is, in the above description, although a case where the present invention is applied to a color printer using an LED unit as an exposure device has been described as an example, a laser scanner or the like may be used as the exposure device. The present invention can also be applied to other image forming apparatuses such as a monochrome printer, a multi function device, and a copier.

In the above description, although a direct transfer method in which a developer image from a photosensitive member is transferred to a sheet during image forming processing has been described as an example, an intermediate transfer method in which a developer image from a photosensitive member is transferred to a transfer belt and a developer image of the transfer belt is transferred to a sheet separately conveyed may be adopted.

In addition to the above, the methods according to the embodiment and the modifications may be appropriately combined and used.

In addition, although not shown, the present invention may be carried out with various modifications within a scope not departing from the gist thereof.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. An image forming apparatus comprising:
a body housing;
an image forming unit configured to form a developer image on a sheet;
a fixing device configured to be detached from an accommodate compartment of the body housing and configured to fix the developer image on the sheet;
an outer cover movable between a closed position where the accommodate compartment is covered and an opened position where the accommodate compartment is uncovered; and
a sheet guide provided between the fixing device and the outer cover and configured to guide, to the image forming unit, the sheet discharged from the fixing device, wherein
the sheet guide is rotatably supported by the body housing about a first guide axis, and is movable between a working position close to the fixing device and a retracted position rotated from the working position to outside of the body housing.

2. The image forming apparatus according to claim 1, further comprising:
a first spring configured to bias the sheet guide such that the sheet guide is located at the retracted position when the outer cover is at the opened position.

3. The image forming apparatus according to claim 1, wherein
the outer cover includes a pressing portion configured to press the sheet guide to be located at the working position when the outer cover is at the closed position, and
the sheet guide includes a pressed portion configured to abut against the pressing portion.

4. The image forming apparatus according to claim 3, wherein
the sheet guide further includes an outer guide surface in which at the working position, the outer guide surface faces an outer cover side, guides the sheet to the image forming unit, and
the pressed portion is located outside of the outer guide surface in a width direction of the sheet.

5. The image forming apparatus according to claim 1, wherein
the outer cover is rotatably supported by the body housing about a cover axis, and
the first guide axis and the cover axal core are parallel to each other, and are located on the same side with respect to the fixing device when viewed from a direction along the first guide axis.

6. The image forming apparatus according to claim 5, wherein
a distance from the cover axis to the fixing device is longer than a distance from the first guide axis to the fixing device, and
a rotation angle of the sheet guide from the working position to the retracted position is larger than a rotation angle of the outer cover from the closed position to the opened position.

7. The image forming apparatus according to claim 1, wherein
at the retracted position, the sheet guide contacts with the outer cover at the opened position.

8. The image forming apparatus according to claim 1, wherein
at the opened position, an outer surface of the outer cover is substantially parallel to a bottom surface of the body housing.

9. The image forming apparatus according to claim 1, wherein
the accommodate compartment includes a fixing guide configured to guide attachment and detachment of the fixing device, and
the fixing guide and the outer surface of the outer cover at the opened position are substantially parallel to each other.

10. The image forming apparatus according to claim 1, wherein
the sheet guide includes an inner guide surface facing a fixing device side and an outer guide surface facing an outer cover side when the sheet guide is at the working position,
the inner guide surface guides the sheet discharged from the fixing device in a first direction, and
the outer guide surface guides, to the image forming unit, the sheet discharged from the fixing device in the first direction and with a conveyance direction thereof being reversed, conveyed in a second direction opposite to the first direction.

11. The image forming apparatus according to claim 1, wherein
the fixing device includes, on one side and the other side along the first guide axis, gripping portions protruding toward the outer cover in a state of being attached to the accommodate compartment, and at the working position, the sheet guide is located between the gripping portion on the one side and the gripping portion on the other side.

12. The image forming apparatus according to claim 1, wherein
the sheet guide includes a base portion that is rotatably supported by the body housing about the first guide axis, and a distal end portion that is rotatably supported by the base portion about a second guide axis, and
when the sheet guide is at the working position, the first guide axis is not located between the fixing device and the outer cover, and the second guide axis is located between the fixing device and the outer cover.

13. The image forming apparatus according to claim 12, wherein
the sheet guide includes a spring configured to bias the distal end portion toward the fixing device when the sheet guide is at the working position.

14. The image forming apparatus according to claim 13, wherein
the spring is a torsion coil spring, and
the second guide axis is located in a coil shape of the spring.

15. The image forming apparatus according to claim 12, wherein
the base portion includes a first boss protruding to outer side in a direction along the first guide axis, and
the body housing includes a hole into which the first boss is respectively inserted.

16. The image forming apparatus according to claim 1, wherein
the sheet guide includes a regulating portion provided at a predetermined location shifted from the first guide axis in a radial direction and configured to regulate an angle of rotation of the sheet guide from the working position toward inside of the accommodate compartment about the first guide axis by abutting against an abutment portion of the body housing.

17. The image forming apparatus according to claim 16, wherein
the regulating portion is provided at the predetermined location to protrude in a direction along the first guide axis.

18. The image forming apparatus according to claim 16, wherein
the predetermined location is a location shifted from the first guide axis in a direction away from the fixing device.

19. The image forming apparatus according to claim 16, wherein
at the working position, a distal end portion of the sheet guide is located above the first guide axis, and
at the working position, a center of gravity of the sheet guide is located at a position closer to outside of the body housing than the first guide axis.
